(19) United States
(12) Patent Application Publication
(10) Pub. No.: US 2026/0056582 A1
(43) Pub. Date: Feb. 26, 2026

(54) DISPLAY DEVICE

(71) Applicant: Samsung Display Co., LTD., Yongin-si (KR)

(72) Inventor: SUNGWON KIM, Yongin-si (KR)

(21) Appl. No.: 19/190,015

(22) Filed: Apr. 25, 2025

(30) Foreign Application Priority Data
Aug. 20, 2024 (KR) 10-2024-0111034

(51) Int. Cl. G06F 1/16; G06F 1/18

(52) U.S. Cl. CPC G06F 1/1652; G06F 1/181

(57) ABSTRACT

A display device includes a display module including a display surface that displays an image, a support part disposed on a rear surface of the display module that faces away from the display surface, the support part including a resin layer and a plurality of support bars arranged in the resin layer in an extension direction of the resin layer, and a shaft that is connected to one end of the support part and has an axis of rotation that extends in a first direction, wherein the display module and the support part are windable around and unwindable from the shaft. A gap between support bars adjacent to each other among the support bars adjacent to the one end of the support part is greater than a gap between support bars adjacent to each other among the support bars adjacent to an opposite end of the support part.

This application claims priority to Korean Patent Application No. 10-2024-0111034, filed on Aug. 20, 2024, and all the benefits accruing therefrom under 35 U.S.C. § 119, the content of which in its entirety is herein incorporated by reference.

### BACKGROUND

Embodiments of the present disclosure described herein relate to a display device.

Electronic devices, such as, for example, a smart phone, a digital camera, a notebook computer, a car navigation unit, a smart television, and the like, which provide an image to a user include a display device for displaying an image. The display device generates an image and provides the generated image to the user through a display screen.

With the development of display device technology, various types of display devices are being developed. For example, various flexible display devices capable of being curved, folded, or rolled are being developed. The flexible display devices may be easy to carry and may improve user convenience.

### SUMMARY

Embodiments of the present disclosure provide a display device for preventing damage to a display module.

According to an embodiment, a display device includes a display module including a display surface that displays an image, a support part disposed on a rear surface of the display module that faces away from the display surface, the support part including a resin layer and a plurality of support bars arranged in the resin layer in an extension direction of the resin layer, and a shaft that is connected to one end of the support part and that has an axis of rotation that extends in a first direction, wherein the display module and the support part are windable around and unwindable from the shaft. A gap between support bars adjacent to each other among the support bars adjacent to the one end of the support part is greater than a gap between support bars adjacent to each other among the support bars adjacent to an opposite end of the support part.

According to an embodiment, an electronic device includes a power supply module, and a display device connected to the power supply module, wherein the display device includes a display module including a display surface that displays an image, a support part disposed on a rear surface of the display module that faces away from the display surface, the support part including a resin layer and a plurality of support bars arranged in the resin layer in an extension direction of the resin layer, and a shaft that is connected to one end of the support part and that has an axis of rotation that extends in a first direction, wherein the display module and the support part are windable around and unwindable from the shaft. The support part is defined by n areas continuous with the one end, n is a natural number greater than 1, and a distance between support bars adjacent to each other decreases as n increases.

### BRIEF DESCRIPTION OF THE FIGURES

The above and other objects and features of the present disclosure will become apparent by describing in detail embodiments thereof with reference to the accompanying drawings.

FIGS. 1A and 1B are perspective views of a display device.

FIG. 2A is a sectional view of the display device corresponding to line I-I′ illustrated in FIG. 1A.

FIG. 2B is a sectional view of the display device corresponding to line II-II′ illustrated in FIG. 1B.

FIG. 3 is a perspective view of the display device illustrated in FIG. 1B as viewed in another direction.

FIG. 4A is a perspective view of a display part illustrated in FIG. 2A.

FIG. 4B is a perspective view illustrating a wound state of the display part illustrated in FIG. 4A.

FIG. 5 is a view illustrating a cross-section of the display part illustrated in FIG. 4A.

FIG. 6 is a perspective view of a support plate illustrated in FIG. 2A.

FIG. 7 is a perspective view illustrating a portion of a support part illustrated in FIG. 2A.

FIG. 8 is a plan view of the support part illustrated in FIG. 7.

FIG. 9 is a sectional view of a shaft, a display module, the support part, and a head bar illustrated in FIG. 2A.

FIG. 10 is an enlarged sectional view of a portion corresponding to a first area A1 illustrated in FIG. 9.

FIGS. 11A to 11C are sectional views for explaining support parts according to comparative examples.

FIG. 12 is a block diagram of an electronic device, according to an embodiment of the present disclosure.

### DETAILED DESCRIPTION

In this specification, when a component (or, an area, a layer, a part, or the like) is referred to as being “on”, “connected to” or “coupled to” another component, this means that the component may be directly on, connected to, or coupled to the other component or a third component may be present therebetween.

Identical reference numerals refer to identical components. In the drawings, the thicknesses, proportions, and dimensions of components are exaggerated for effective description. As used herein, the term “and/or” includes all of one or more combinations defined by related components.

Terms such as first, second, and the like may be used to describe various components, but the components should not be limited by the terms. The terms as used herein may distinguish one component from other components. For example, without departing the scope of the present disclosure, a first component may be referred to as a second component, and similarly, the second component may also be referred to as the first component. The terms of a singular form may include plural forms unless otherwise specified.

Terms such as, for example, “below”, “under”, “above”, and “over” are used to describe a relationship between components illustrated in the drawings. The terms are relative concepts and are described based on directions illustrated in the drawing.

It should be understood that terms such as, for example, “comprise”, “include”, and “have”, when used herein, specify the presence of stated features, numbers, steps, operations, components, parts, or combinations thereof, but do not preclude the presence or addition of one or more other features, numbers, steps, operations, components, parts, or combinations thereof.

The term “substantially,” as used herein, means approximately or actually. The term “substantially equal” means approximately or actually equal. The term “substantially the same” means approximately or actually the same. The term “substantially similar” means approximately or similar.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinafter, embodiments of the present disclosure will be described with reference to the accompanying drawings.

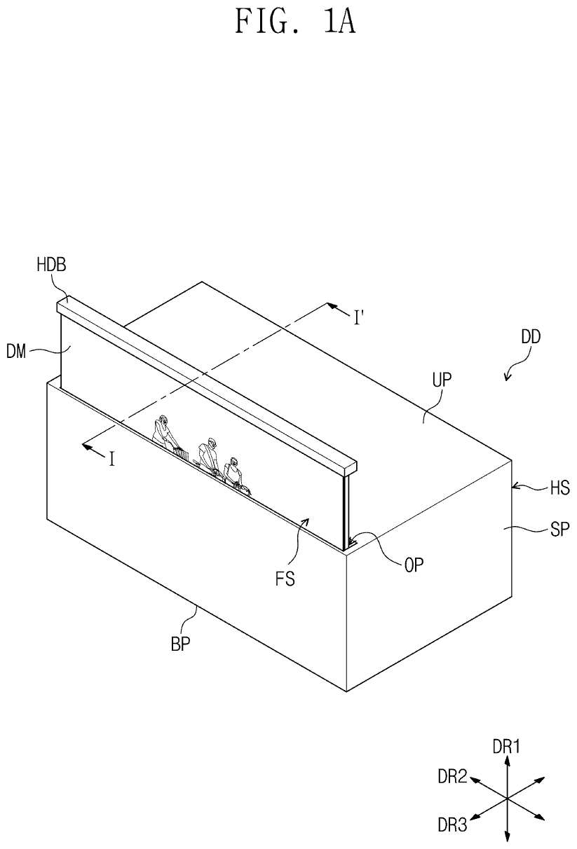

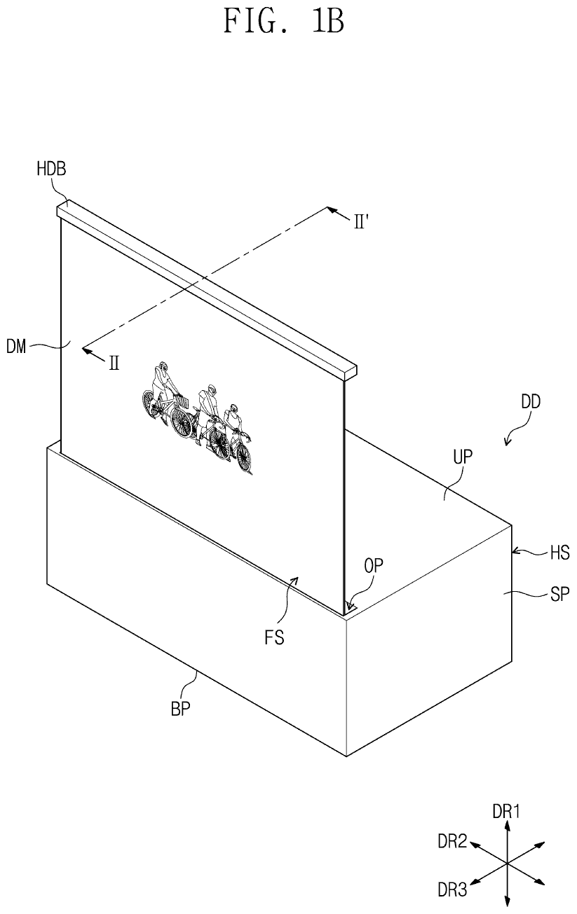

FIGS. 1A and 1B are perspective views of a display device.

Referring to FIGS. 1A and 1B, the display device DD may include a housing HS, a head bar HDB, and a display module DM. For example, the housing HS may have a box shape. However, the shape of the housing HS is not limited thereto. An opening OP that is open in a first direction DR1 may be defined in the housing HS.

Hereinafter, a direction crossing the first direction DR1 is defined as a second direction DR2. In some aspects, a direction crossing a plane defined by the first direction DR1 and the second direction DR2 is defined as a third direction DR3. The housing HS may include a bottom part BP, an upper part UP, and

sidewall parts SP. The opening OP may be defined in the upper part UP. The bottom part BP and the upper part UP may have a plane defined by the second direction DR2 and the third direction and DR3. The bottom part BP and the upper part UP may face each other in the first direction DR1. The sidewall parts SP may extend from the periphery of the bottom part BP to the periphery of the upper part UP.

The head bar HDB may be disposed over the opening OP. The head bar HDB may move toward or away from the housing HS in the first direction DR1. Hereinafter, a state in which the head bar HDB moves toward the housing HS may be defined as a closed mode, and a state in which the head bar HDB moves away from the housing HS may be defined as an open mode.

One portion of the display module DM may be accommodated in the housing HS, and another portion of the display module DM may be exposed outside the housing HS. The display module DM may move into or out of the housing HS through the opening OP. Outside the housing HS, the display module DM may have a plane defined by the first direction DR1 and the second direction DR2.

The display module DM may be connected to the head bar HDB. One end of the display module DM may be connected to the head bar HDB, and the display module DM may move together with the head bar HDB. In an example in which the head bar HDB moves toward or away from the housing HS in the first direction DR1, the display module DM may move in the first direction DR1 together with the head bar HDB. The area of the display module DM exposed outside the housing HS may be expanded or reduced depending on the movement of the head bar HDB.

A front surface FS of the display module DM may be defined as a display surface and may have a plane defined by the first direction DR1 and the second direction DR2. An image generated by the display module DM may be provided to a user through the front surface FS.

Although not illustrated, function buttons may be disposed on the housing HS. The function buttons may provide various functions to the display device DD. For example, the display module DM may be moved into or out of the housing HS by manipulations of the function buttons. In some aspects, the luminance and clarity of an image displayed on the display module DM may be controlled by manipulations of the function buttons.

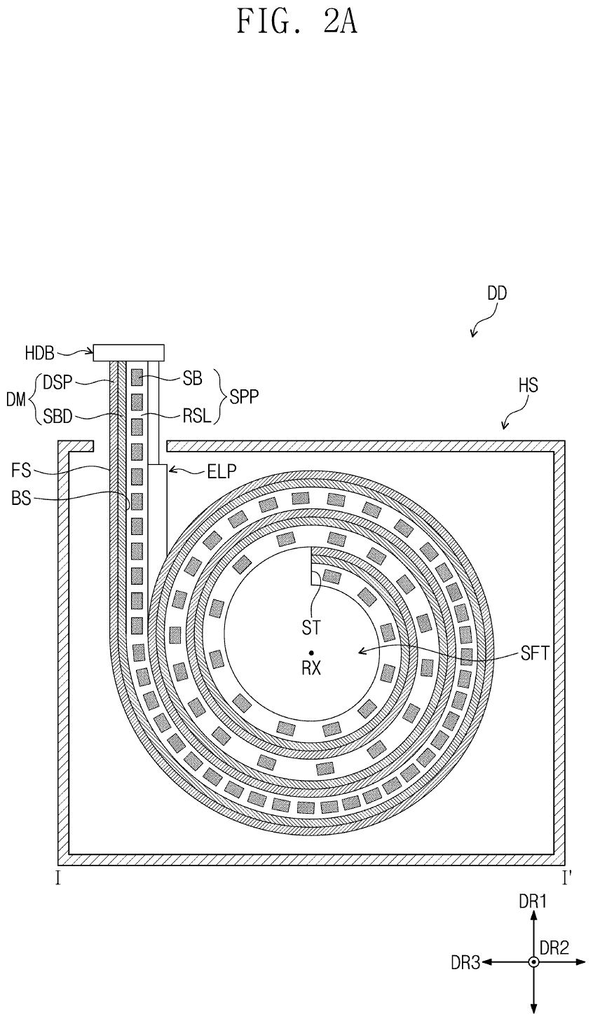

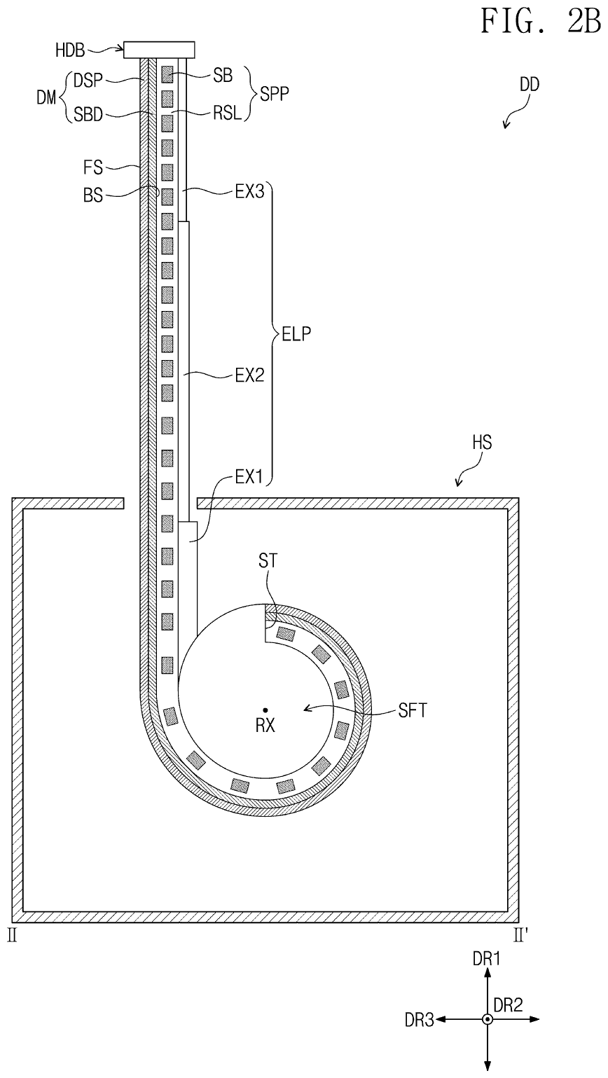

FIG. 2A is a sectional view of the display device corresponding to line I-I′ illustrated in FIG. 1A. FIG. 2B is a sectional view of the display device corresponding to line II-II′ illustrated in FIG. 1B.

Among the components illustrated in FIGS. 2A and 2B, components identical to the components described with reference to the above-described drawings will be omitted from the description or will be briefly described.

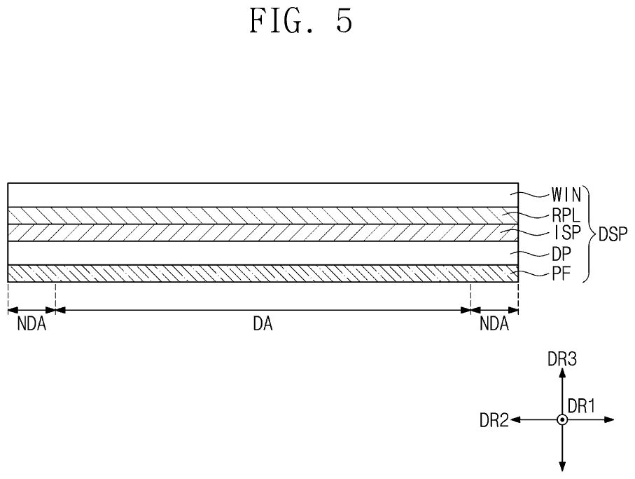

Referring to FIGS. 2A and 2B, the display module DM may include a display part DSP and a support plate SBD. A front surface FS of the display part DSP may correspond to the front surface FS of the display module DM illustrated in FIG. 1A. The display part DSP will be described in detail with reference to FIG. 5.

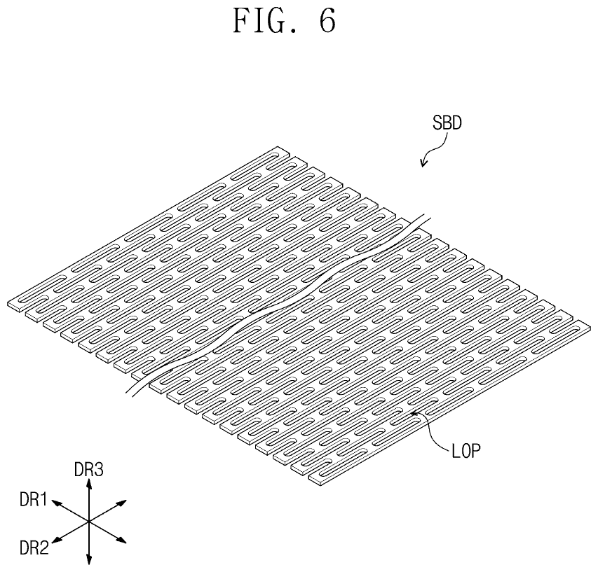

The support plate SBD may be disposed on a rear surface of the display part DSP that faces away from the front surface FS of the display part DSP in the third direction DR3. Although not illustrated, the support plate SBD may be attached to the rear surface of the display part DSP through a pressure sensitive adhesive. The support plate SBD may support the display part DSP. The support plate SBD will be described in detail with reference to FIG. 6.

The display device DD may further include a shaft SFT, a support part SPP, and a lifting part ELP. The shaft SFT may be disposed in the housing HS. The shaft SFT may rotate clockwise and counterclockwise about an axis of rotation RX parallel to the second direction DR2. Although not illustrated, the display device DD may further include an actuator for rotating the shaft SFT.

The shaft SFT may have at least two curvatures. Specifically, the radius of the shaft SFT may be varied when viewed in the second direction DR2. The radius of the shaft SFT may be defined as the length from the axis of rotation RX to the outer peripheral surface of the shaft SFT. For example, the shaft SFT may have a spiral shape. The outer peripheral surface of the shaft SFT may be defined as a surface that faces the lower surface of the support part SPP that will be described herein.

The shaft SFT may include a step ST on the outer peripheral surface of the shaft SFT. An opposite end of the display module DM may be connected to the shaft SFT. The opposite end of the display module DM may be connected to the step ST. The opposite end of the display module DM and the outer peripheral surface of the shaft SFT adjacent to the step ST may have the same curvature.

The display module DM and the support part SPP may each be windable around the shaft SFT and unwindable from the shaft SFT, example aspects of which are described herein.

One portion of the display module DM may be wound around the shaft SFT, and another portion of the display module DM may be disposed to overlap the lifting part ELP without being wound around the shaft SFT. In the closed mode, the display module DM may be wound around the shaft SFT, and the one end of the display module DM may be adjacent to the opening OP. In the open mode, the display module DM may be unwound from the shaft SFT, and the one end of the display module DM may move away from the opening OP.

The support part SPP may be disposed on a rear surface BS of the display module DM that faces away from the front surface FS of the display module DM in the third direction DR3. The display module DM may be disposed on the upper surface of the support part SPP. The rear surface BS of the display module DM may correspond to the rear surface of the support plate SBD. The support part SPP may support the display module DM. Although not illustrated, the support part SPP may be attached to the rear surface BS of the display module DM through a pressure sensitive adhesive.

One end of the support part SPP may be connected to the head bar HDB and may move together with the head bar HDB. In an example in which the head bar HDB moves toward or away from the housing HS in the first direction DR1, the display module DM may move in the first direction DR1 together with the head bar HDB.

An opposite end of the support part SPP may be connected to the shaft SFT. The opposite end of the support part SPP may be connected to the step ST. One portion of the support part SPP may be wound around the shaft SFT, and another portion of the support part SPP may be disposed to overlap the lifting part ELP without being wound around the shaft SFT. In the closed mode, the support part SPP may be wound around the shaft SFT, and the one end of the support part SPP may be adjacent to the opening OP. In the open mode, the support part SPP may be unwound from the shaft SFT, and the one end of the support part SPP may move away from the opening OP.

The support part SPP may include a resin layer RSL and a plurality of support bars SB. One end of the resin layer RSL may be connected to the head bar HDB. An opposite end of the resin layer RSL may be connected to the shaft SFT.

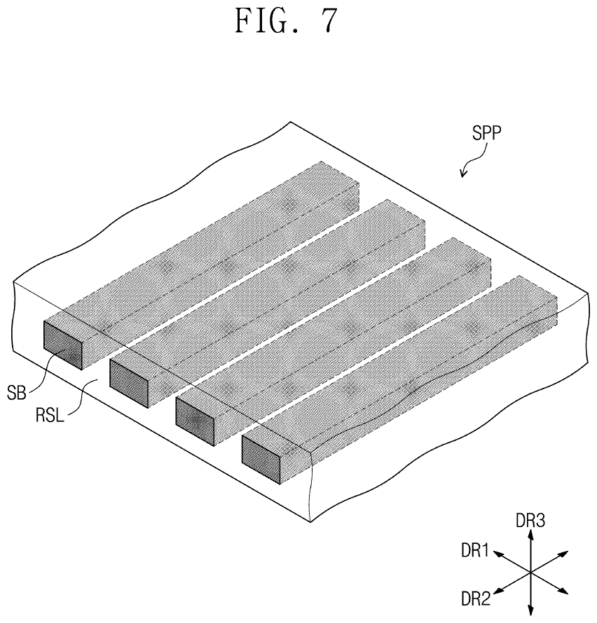

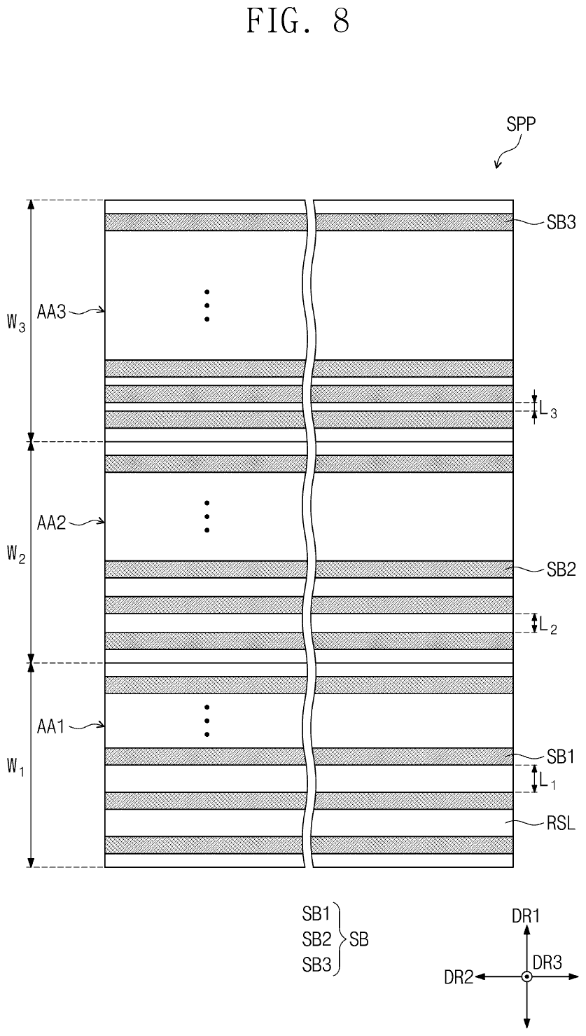

The support bars SB may be disposed in the resin layer RSL. The support bars SB disposed in the resin layer RSL wound around the shaft SFT may be arranged in a circular shape. The support bars SB disposed in the resin layer RSL that is not wound around the shaft SFT may be arranged in the first direction DR1. The resin layer RSL and the support bars SB will be described in detail with reference to FIGS. 7 and 8.

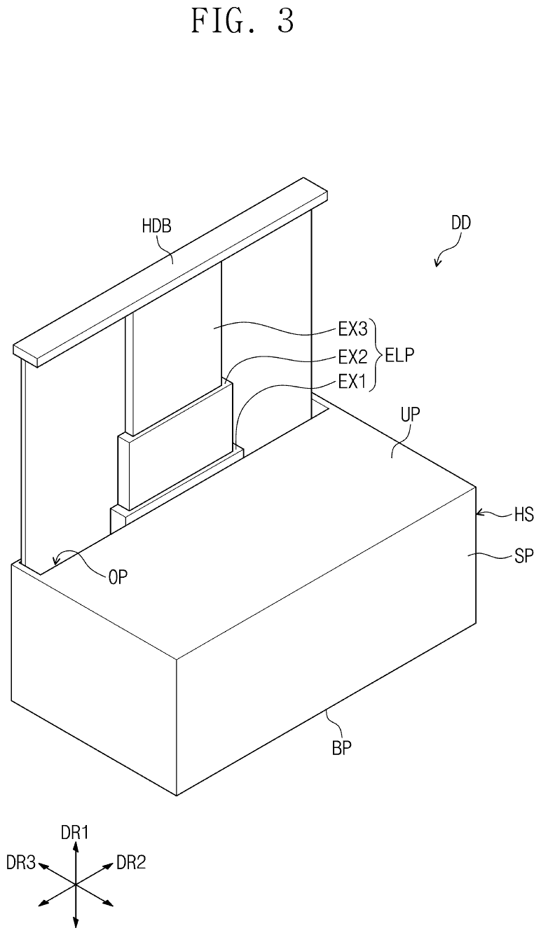

FIG. 3 is a perspective view of the display device illustrated in FIG. 1B as viewed in another direction.

Among the components illustrated in FIG. 3, components identical to the components described with reference to the above-described drawings will be omitted from the description or will be briefly described.

Referring to FIGS. 2A to 3, the lifting part ELP may be accommodated in the housing HS. The lifting part ELP may be adjacent to the opening OP. The lifting part ELP may be connected to the head bar HDB. The lifting part ELP may be disposed on the rear surface of the support part SPP. The lower surface of the support part SPP may be defined as a surface that faces away from the upper surface of the support part SPP in the third direction DR3.

When the display module DM and the support part SPP are unwound from the shaft SFT and withdrawn from the housing as illustrated in FIGS. 2B and 3, the lifting part ELP connected to the head bar HDB may extend outside the housing HS through the opening OP. The lifting part ELP, which extends outside the housing HS, may support the display module DM and the support part SPP at the outside of the housing HS.

The lifting part ELP may include a first extension EX1, a second extension EX2, and a third extension EX3 such that the lifting part ELP extends outside the housing HS. The second extension EX2 may be disposed between the first extension EX1 and the third extension EX3.

The lifting part ELP may retract in the first direction DR1 when the display module DM is wound around the shaft SFT.

To implement a structure capable of extending like an antenna, the second extension EX2 may be inserted into and withdrawn from the first extension EX1, and the third extension EX3 may be inserted into and withdrawn from the second extension EX2. The first extension EX1 may be disposed in the housing HS, and the second extension EX2 and the third extension EX3 may move out of the housing HS. The third extension EX3 may be connected to the head bar HDB.

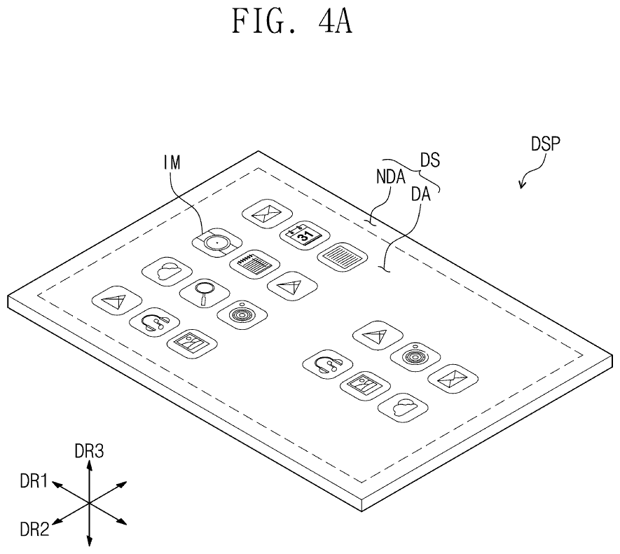

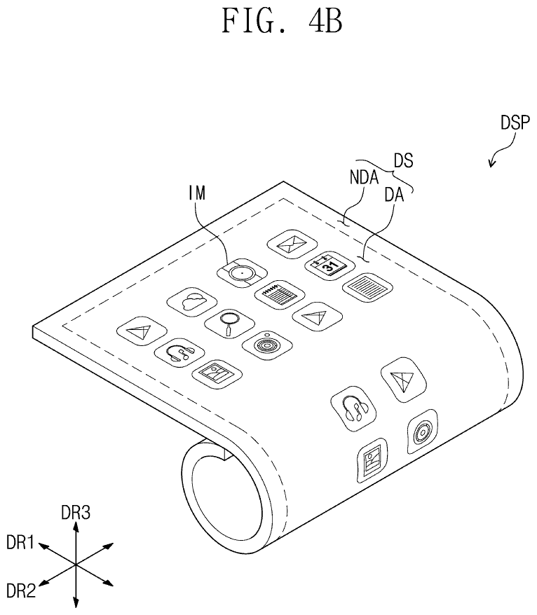

FIG. 4A is a perspective view of the display part illustrated in FIG. 2A. FIG. 4B is a perspective view illustrating a wound state of the display part illustrated in FIG. 4A.

For example, FIG. 4A illustrates the display part DSP in a flat, unrolled state.

Referring to FIG. 4A, the display part DSP may have a rectangular shape with long sides extending in the first direction DR1 and short sides extending in the second direction DR2. However, without being limited thereto, the display part DSP may have various shapes such as, for example, a circular shape, a polygonal shape, or the like.

The front surface FS of the display module DM may be defined as a display surface FS and may have a plane defined by the first direction DR1 and the second direction DR2. Images IM generated by the display module DM may be provided to the user through the display surface FS.

The display surface FS may include a display area DA and a non-display area NDA around the display area DA. The display area DA may display an image, and the non-display area NDA may not display an image. The non-display area NDA may surround the display area DA and may define the border of the display module DM that is printed in a certain color.

Referring to FIG. 4B, the display part DSP may be a flexible display module. The display part DSP may be rolled up like a roll. The display part DSP may be rolled up in the first direction DR1. The display part DSP may be rolled up from one side of the display part DSP. The display part DSP may be rolled up such that the display surface FS faces outward. However, without being limited thereto, the display surface FS may be rolled up to face inward.

FIG. 5 is a view illustrating a cross-section of the display part illustrated in FIG. 4A.

For example, FIG. 5 illustrates a cross-section of the display part DSP viewed in the first direction DR1.

Referring to FIG. 5, the display part DSP may include a display panel DP, an input sensing part ISP, an anti-reflective layer RPL, a window WIN, and a panel protection film PF.

The display panel DP may be a flexible display panel. The display panel DP according to an embodiment of the present disclosure may be an emissive display panel, but is not particularly limited. For example, the display panel DP may be an organic light emitting display panel or an inorganic light emitting display panel. An emissive layer of the organic light emitting display panel may include an organic luminescent material. An emissive layer of the inorganic light emitting display panel may include quantum dots, quantum rods, and the like. Hereinafter, in accordance with one or more example embodiments of the present disclosure, the display panel DP is an organic light emitting display panel.

The input sensing part ISP may be disposed on the display panel DP. The input sensing part ISP may include a plurality of sensor units (not illustrated) for sensing an external input in a capacitance type. The input sensing part ISP may be directly manufactured on the display panel DP when the display device DD is manufactured. However, without being limited thereto, the input sensing part ISP may be manufactured as a panel separate from the display panel DP and may be attached to the display panel DP by an adhesive layer.

The anti-reflective layer RPL may be disposed on the input sensing part ISP. The anti-reflective layer RPL may be directly formed on the input sensing part ISP or may be coupled to the input sensing part ISP by an adhesive layer. The anti-reflective layer RPL may be defined as a film for preventing the reflection of external light. The anti-reflective layer RPL may decrease the reflectance of external light incident toward the display panel DP from above the display device DD.

When external light travelling toward the display panel DP is reflected from the display panel DP and provided back to the user, the user may visually recognize the external light as in a mirror. To prevent such a phenomenon, the anti-reflective layer RPL may include a plurality of color filters that display light of the same colors as those of pixels of the display panel DP.

The color filters may filter external light into the same colors as those of the pixels. In this case, the external light may not be visible to the user. However, without being limited thereto, the anti-reflective layer RPL may include a polarizer film for decreasing the reflectance of the external light. The polarizer film may include a phase retarder and/or a polarizer.

The window WIN may be disposed on the anti-reflective layer RPL. The window WIN may be directly formed on the anti-reflective layer RPL or may be coupled to the anti-reflective layer RPL by an adhesive layer. The window WIN may protect the display panel DP, the input sensing part ISP, and the anti-reflective layer RPL from external scratches and impacts.

The panel protection film PF may be disposed under the display panel DP. The panel protection film PF may be directly formed on the bottom of the display panel DP or may be coupled to the display panel DP by an adhesive layer. The panel protection film PF may protect the bottom of the display panel DP. The panel protection film PF may include a flexible plastic material such as, for example, polyethylene terephthalate (PET).

FIG. 6 is a perspective view of the support plate illustrated in FIG. 2A.

For example, FIG. 6 illustrates the support plate SBD in a flat, unrolled state.

Referring to FIG. 6, a grid pattern may be defined in the support plate SBD. For example, a plurality of openings LOP may be defined in the support plate SBD. The openings LOP may be arranged according to a predetermined rule. The openings LOP may be arranged in a grid form to form a grid pattern in the entire area of the support plate SBD.

Since the openings LOP are defined in the entire area of the support plate SBD, the area of the support plate SBD may be decreased, and thus the rigidity of the support plate SBD may be lowered. Accordingly, when the openings LOP are defined in the support plate SBD, the flexibility of the support plate SBD may be improved, as compared with when the openings LOP are not defined in the support plate SBD. As a result, the support plate SBD may be more easily rolled up.

The openings LOP may be arranged in the first direction DR1 and the second direction DR2. The openings LOP may extend longer in the second direction DR2 than in the first direction DR1. The openings LOP adjacent to one another in the first direction DR1 may be staggered with respect to one another.

The support plate SBD may include a metallic material such as, for example, stainless steel. For example, the support plate SBD may include STS 316. However, without being limited thereto, the support plate SBD may include various metallic materials.

FIG. 7 is a perspective view illustrating a portion of the support part illustrated in FIG. 2A.

Among the components illustrated in FIG. 7, components identical to the components described with reference to the above-described drawings will be omitted from the description or will be briefly described.

Referring to FIGS. 2B and 7, the support part SPP may include the resin layer RSL and the support bars SB.

The resin layer RSL may include an elastomer having a certain elastic force. For example, the resin layer RSL may include at least one of thermoplastic polyurethane, silicone, thermoplastic rubbers, elastolefin, thermoplastic olefin, polyamide, polyether block amide, synthetic polyisoprene, polybutadiene, chloroprene rubber, butyl rubber, styrene-butadiene, epichlorohydrin rubber, polyacrylic rubber, silicone rubber, fluorosilicone rubber, fluoroelastomers, and ethylene-vinyl acetate.

The support bars SB may be disposed in the resin layer RSL. In a state in which the support part SPP is unrolled, the support bars SB may extend in the second direction DR2 and may be arranged in the first direction DR1. When the resin layer RSL is wound around the shaft SFT as illustrated in FIG. 2A (i.e., in a state in which the resin layer RSL is partially or fully wound around the shaft SFT), the support bars SB disposed in the resin layer RSL may be arranged corresponding to the shape of the resin layer RSL. The support bars SB may be arranged in the extension direction of the resin layer RSL.

The support bars SB may be of a rigid type. For example, the support bars SB may include a fiber reinforced composite. The fiber reinforced composite may be carbon fiber reinforced plastic (CFRP) or glass fiber reinforced plastic (GFRP). However, without being limited thereto, the support bars SB may include metal. The support bars SB may have a higher modulus than the resin layer RSL.

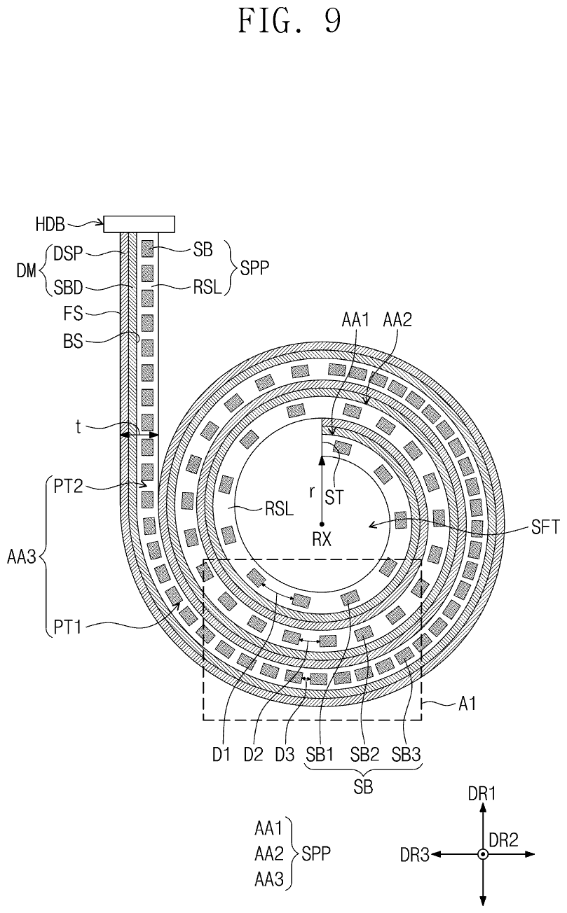

FIG. 8 is a plan view of the support part illustrated in FIG. 7. FIG. 9 is a sectional view of the shaft, the display module, the support part, and the head bar illustrated in FIG. 2A.

For example, FIG. 8 illustrates the support part SPP in a flat, unrolled state, and FIG. 9 illustrates the support part SPP wound around the shaft SFT.

Among the components illustrated in FIGS. 8 and 9, descriptions of components identical to the components described with reference to the above-described drawings will be omitted from the description or will be briefly described.

Referring to FIGS. 8 and 9, the support part SPP may include n areas. The n areas may be arranged in the first direction DR1 when the support part SPP is unrolled flat. The first to n^{th} areas may be continuously arranged in the first direction DR1. “n” is a natural number greater than 1. Expressed another way, the first area may be continuous with a second area, the second area may be continuous with a third area, and a (n−1)^{th} area may be continuous with a n^{th} area.

In a state in which the support part SPP is wound around the shaft SFT (e.g., partially or fully wound around the shaft SFT), the (n−1)^{th} area may be defined as an area that surrounds the shaft SFT once. The n^{th} area may include a first portion PT1 that surrounds a portion of the shaft SFT and a second portion PT2 that does not surround the shaft SFT. Hereinafter, as an example, n is 3.

For example, as illustrated in FIG. 9, the first area AA1 and the second area AA2 may each surround the shaft SFT once. The first portion PT1 of the third area AA3 may surround a portion of the shaft SFT. The second portion PT2 of the third area AA3 may be spaced apart from the shaft SFT without surrounding the shaft SFT.

In the state in which the support part SPP is wound around the shaft SFT, the lower surface of the first area AA1 adjacent to the shaft SFT among the n areas may be disposed on the outer peripheral surface of the shaft SFT and, in some aspects, make contact with the outer peripheral surface of the shaft SFT. The lower surface of the second area AA2 may be disposed on the front surface FS of the display module DM disposed on the upper surface of the first area AA1. The lower surface of the third area AA3 may be disposed on the front surface FS of the display module DM disposed on the upper surface of the second area AA2 and, in some aspects, make contact with the front surface FS of the display module DM. The upper surfaces of the first to third areas AA1 to AA3 may be defined as surfaces facing away from the lower surface.

The n areas may have the same length in the second direction DR2. The n areas may have different lengths Wₙ in the first direction DR1. The first length W₁ defined as the length of the first area AA1 in the first direction DR1 may be 2π(r+t). Here, “r” may be the radius of the shaft SFT adjacent to the step ST. The radius of the shaft SFT may be defined as the distance from the axis of rotation RX to the outer peripheral surface of the shaft SFT that is adjacent to the step ST. “t” may be defined as the sum of the thickness of the display module DM and the thickness of the support part SPP.

The length Wₙ of each of the n areas other than the first area AA1 in the first direction DR1 may be determined by the following equation.

$${W}_{n} = 2 π ( r + nt ) \qquad [ Equation 1 ]$$

For example, the second length W₂ defined as the length of the second area AA2 in the first direction DR1 may be 2π(r+2t). The third length W₃ defined as the length of the third area AA3 in the first direction DR1 may be 2π(r+3t).

The length Wₙ of the n^{th} area in the first direction DR1 may increase as the distance from the shaft SFT increases. The second length W₂ may be greater than the first length W₁. The second length W₂ may be smaller than the third length W₃. The area of the second area AA2 may be greater than the area of the first area AA1. The area of the second area AA2 may be smaller than the area of the third area AA3.

The support bars SB may include first to n^{th} support bars. In an example in which n is 3, the support bars SB may include the first to third support bars SB1 to SB3. The first support bars SB1 may be defined as support bars SB disposed in the first area AA1. The second support bars SB2 may be defined as support bars SB disposed in the second area AA2. The third support bars SB3 may be defined as support bars SB disposed in the third area AA3.

When the support part SPP is unrolled flat (i.e., in a completely unrolled state or completely unwound state), the distance between support bars SB adjacent to each other in the first direction DR1 among the support bars SB disposed in the resin layer RSL may be changed. The distance between the first support bars SB1 adjacent to each other in the first direction DR1 may be defined as a first distance L₁. The distance between the second support bars SB2 adjacent to each other in the first direction DR1 may be defined as a second distance L₂. The distance between the third support bars SB3 adjacent to each other in the first direction DR1 may be defined as a third distance L₃. The first distance L₁, the second distance L₂, and the third distance L₃ may be different from one another.

The distance between the support bars SB adjacent to each other in the first direction DR1 may be determined by the following equation.

$${L}_{n} = {L}_{1} - {L}_{1} \times ( \frac{{W}_{n}}{{W}_{1}} - 1 ) = {L}_{1} - {L}_{1} \times ( \frac{( r + nt )}{( r + t )} - 1 ) \qquad [ Equation 2 ]$$

Wₙ may be defined as the length of the n^{th} area in the first direction DR1. The distance between the support bars SB adjacent to each other in the first direction DR1 may be determined by the ratio of the n^{th} length Wₙ of the n^{th} area to the first length W₁ of the first area AA1. For example, the second distance L₂ may be smaller than the first distance L₁. The second distance L₂ may be greater than the third distance L₃. The distance between support bars SB adjacent to each other among the support bars SB disposed at the opposite end of the support part SPP may be greater than the distance between support bars SB adjacent to each other among the support bars SB disposed at the one end of the support part SPP. That is, the distance between the support bars SB adjacent to each other in the first direction DR1 may decrease as n increases.

As the distance between the support bars SB adjacent to each other in the first direction DR1 is varied, the volume of the resin layer RSL disposed between the support bars SB adjacent to each other in the first direction DR1 may also be varied. For example, the volume of the resin layer RSL disposed between the second support bars SB2 adjacent to each other in the first direction DR1 may be smaller than the volume of the resin layer RSL disposed between the first support bars SB1 adjacent to each other in the first direction DR1. The volume of the resin layer RSL disposed between the third support bars SB3 adjacent to each other in the first direction DR1 may be smaller than the volume of the resin layer RSL disposed between the second support bars SB2 adjacent to each other in the first direction DR1.

The number of first support bars SB1 disposed in the first area AA1 may be smaller than the number of second support bars SB2 disposed in the second area AA2 having a larger area than the first area AA1. The number of second support bars SB2 disposed in the second area AA2 may be smaller than the number of third support bars SB3 disposed in the third area AA3 having a larger area than the second area AA2.

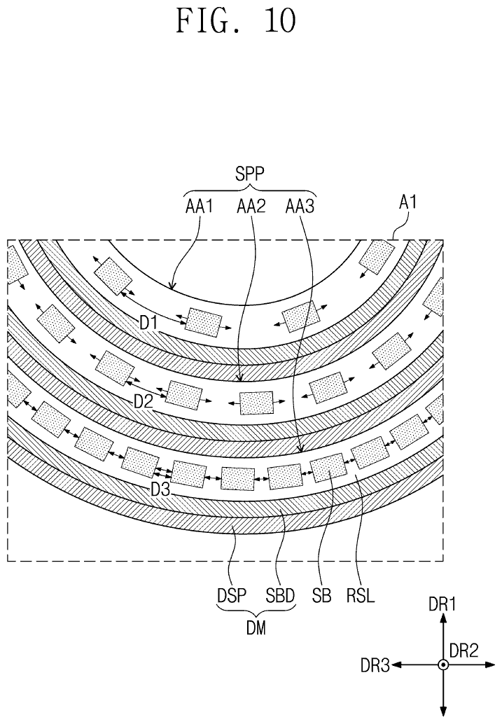

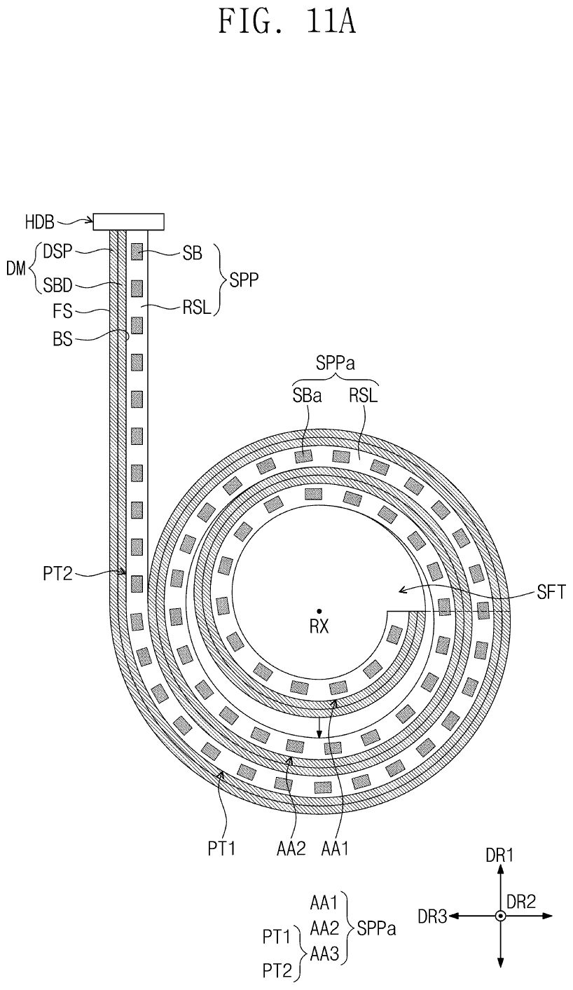

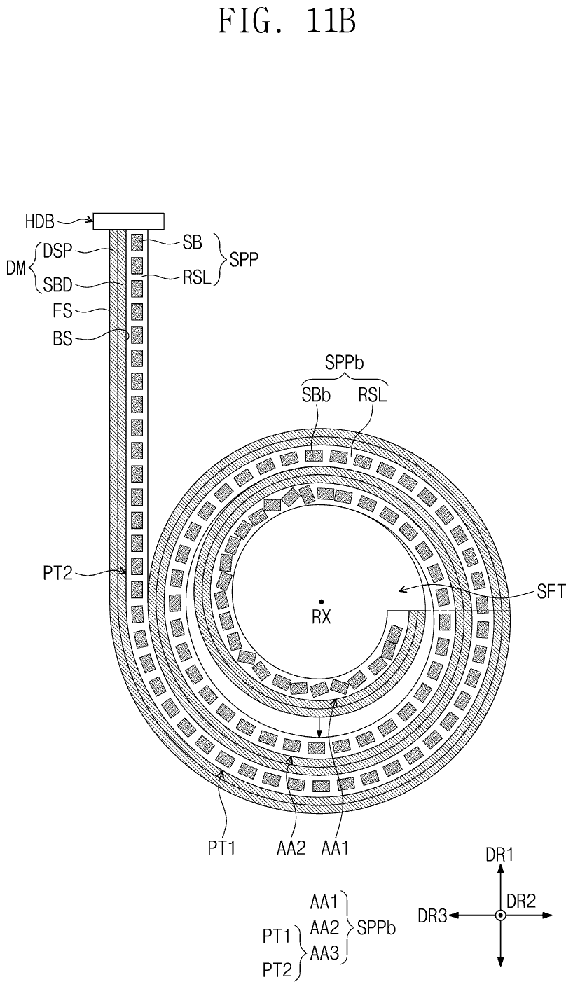

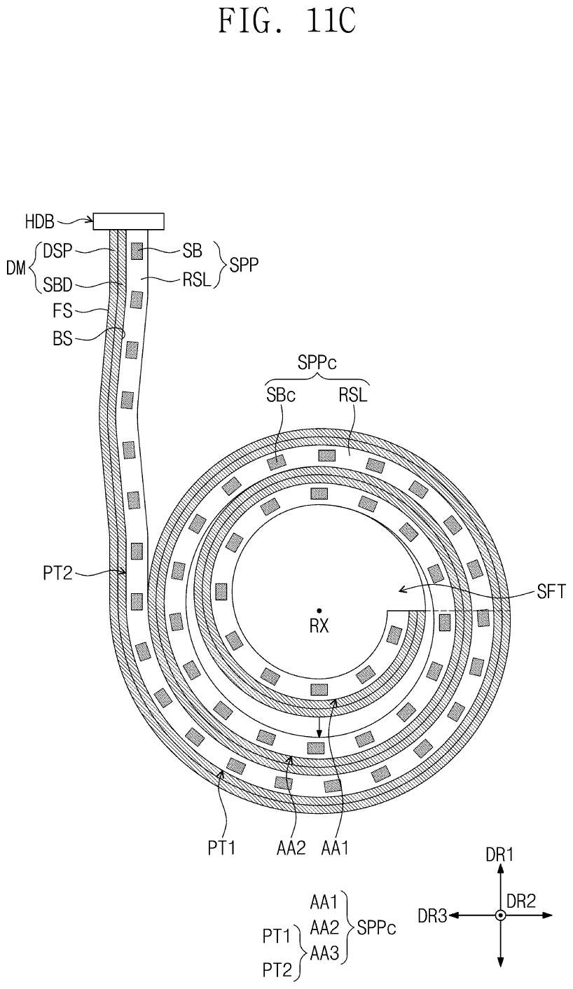

FIG. 10 is an enlarged sectional view of a portion corresponding to a first area A1 illustrated in FIG. 9. FIGS. 11A to 11C are sectional views for explaining support parts according to comparative examples.

For example, in FIGS. 10 to 11C, the housing HS and the lifting part ELP illustrated in FIG. 2A are omitted.

Among the components illustrated in FIGS. 10A to 11C, components identical to the components described with reference to the above-described drawings will be omitted from the description or will be briefly described.

Referring to FIG. 10, tensile stress may be applied to the support part SPP when the support part SPP and the display module DM are wound around the shaft SFT. The tensile stress may increase as n increases. For example, the magnitude of tensile stress applied to the second area AA2 may be greater than the magnitude of tensile stress applied to the first area AA1. The magnitude of tensile stress applied to the third area AA3 may be greater than the magnitude of tensile stress applied to the second area AA2. The resin layer RSL disposed between the adjacent support bars SB may be stretched by the tensile stress.

Referring to FIG. 11A, when the distance between adjacent support bars SBa is constant irrespective of the positions of the support bars SBa, a separation phenomenon in which the second area AA2 is spaced apart from the display module DM disposed on the upper surface of the first area AA1 may occur due to an increase in the length of the resin layer RSL. The curvatures of a portion of the second area AA2 and a portion of the third area AA3 where the separation phenomenon occurs may be sharply changed. Due to this, stress may be concentrated on the portion of the second area AA2 and the portion of the third area AA3. Therefore, the display part DSP disposed on the upper surface of the portion of the second area AA2 and the upper surface of the portion of the third area AA3 may be damaged.

Referring to FIG. 11B, when the gap between adjacent support bars SBb is reduced to decrease the length of the resin layer RSL disposed between the support bars SBb, support bars SBb adjacent to each other among the support bars SBb disposed in the first area AA1 may interfere with each other.

Referring to FIG. 11C, when the distance between support bars SBc adjacent to each other is increased to prevent the adjacent support bars SBc from interfering with each other, the distance between the support bars SB c disposed in the second portion PT2 may also be increased. Due to this, the length of the resin layer RSL disposed between the support bars SBc adjacent to each other may also be increased. Therefore, the rigidity of the second portion PT2 may be decreased, and the display module DM overlapping the second portion PT2 may be bent.

Referring to FIGS. 9 and 10, according to an embodiment of the present disclosure, the distance between the support bars SB adjacent to each other may decrease as n increases. For example, among the first to third distances D1, D2, and D3, the first distance D1 may be the largest, and the third distance D3 may be the smallest.

Since the second distance D2 and the third distance D3 are smaller than the first distance D1, a separation phenomenon may be prevented even though the resin layer RSL disposed between the second support bars SB2 and between the third support bars SB3 is stretched. Accordingly, the curvatures of the first to third areas AA1 to AA3 may be constant without being sharply changed, and concentration of stress on a portion of the support part SSP may be prevented. Thus, the display module DM disposed on the upper surface of the support part SSP may be prevented from being damaged.

Furthermore, since the first distance D1 is set such that the first support bars SB1 do not interfere with each other, the first support bars SB1 adjacent to each other may not interfere with each other, and a defect in the display device DD may be prevented.

In some aspects, the length of the resin layer RSL disposed between the third support bars SB3 of the second portion PT2 may be decreased, and the rigidity of the second portion PT2 may increase accordingly. Thus, the display module DM may be prevented from being bent.

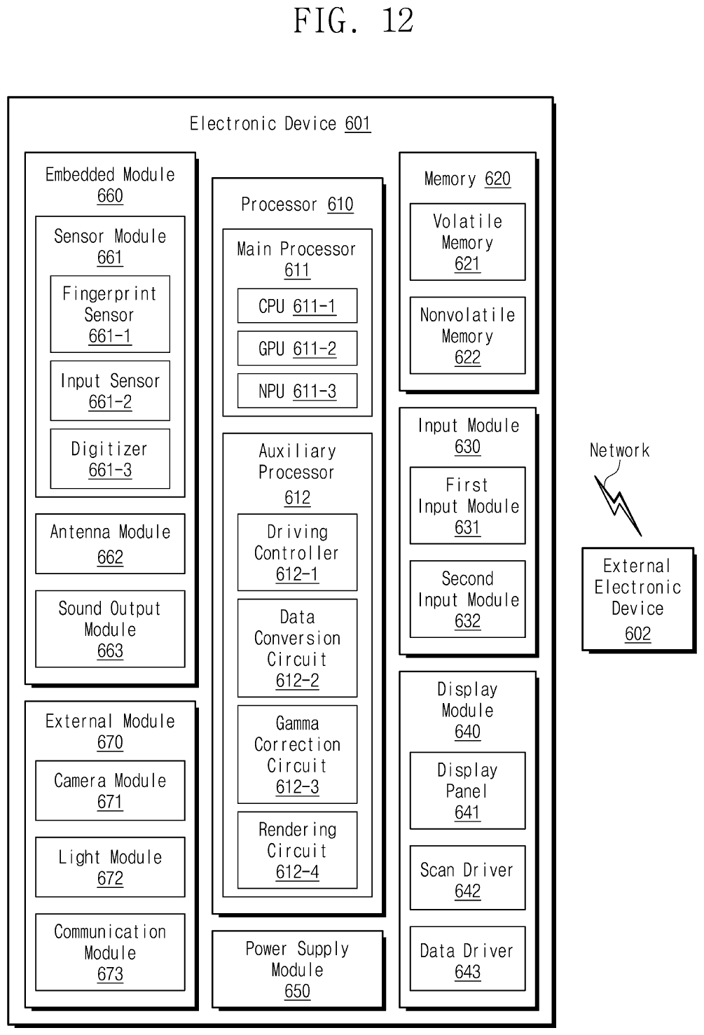

FIG. 12 is a block diagram of an electronic device, according to an embodiment of the present disclosure.

Referring to FIG. 12, an electronic device 601 outputs various pieces of information through a display module 640 within an operating system. In an example in which a processor 610 executes an application stored in a memory 620, a display module 640 provides application information to a user through a display panel 641.

The processor 610 obtains an external input through an input module 630 or a sensor module 661 and executes an application corresponding to the external input. In an example in which the user selects a camera icon displayed on the display panel 641, the processor 610 obtains a user input through an input sensor 661-2 and activates a camera module 671. The processor 610 delivers image data corresponding to a captured image obtained through the camera module 671 to the display module 640. The display module 640 may display an image corresponding to the captured image through the display panel 641.

In another example, when personal information is authenticated on the display module 640, a fingerprint sensor 661-1 obtains entered fingerprint information as input data. The processor 610 compares input data obtained through the fingerprint sensor 661-1 with authentication data stored in the memory 620 and executes an application based on the comparison result. The display module 640 may display information, which is executed depending on the logic of the application, through the display panel 641.

In another example, when a music streaming icon displayed on the display module 640 is selected, the processor 610 obtains a user input through the input sensor 661-2 and activates the music streaming application stored in the memory 620. In an example in which a music play command is input by the music streaming application, the processor 610 provides audio information corresponding to the music play command to the user by activating an audio output module 663.

The operation of the electronic device 601 has been briefly described herein. Hereinafter, a configuration of the electronic device 601 will be described in detail. Some of components of the electronic device 601, which will be described herein, may be integrated and provided as one configuration, or the one configuration may be provided to be separated into two or more configurations.

Referring to FIG. 12, the electronic device 601 may communicate with an external electronic device 602 through a network (e.g., a short-range wireless communication network or a long-range wireless communication network). According to an embodiment, the electronic device 601 may include the processor 610, the memory 620, the input module 630, the display module 640, a power supply module 650, an embedded module 660, and an external module 670. According to an embodiment, in the electronic device 601, at least one of the above-described components may be omitted, or one or more other components may be added. According to an embodiment, some (e.g., the sensor module 661, an antenna module 662, or the audio output module 663) of the components described herein may be integrated into another component (e.g., the display module 640).

The processor 610 may execute software to control at least another component (e.g., hardware or software component) of the electronic device 601 connected to the processor 610, and may process and calculate various types of data. According to an embodiment, as at least part of data processing or calculation, the processor 610 may store instructions or data received from other components (e.g., the input module 630, the sensor module 661 or a communication module 673) into a volatile memory 621, may process instructions or data stored in the volatile memory 621. The result data may be stored in a nonvolatile memory 622.

The processor 610 may include a main processor 611 and an auxiliary processor 612. The main processor 611 may include one or more of a central processing unit (CPU) 611-1 or an application processor (AP). The main processor 611 may further include one or more of a graphic processing unit (GPU) 611-2, a communication processor (CP), and an image signal processor (ISP). The main processor 611 may further include a neural processing unit (NPU) 611-3. The NPU 611-3 may be a processor that is specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described herein may be implemented as one integrated component (e.g., a single chip) or may be implemented as independent components (e.g., a plurality of chips).

The auxiliary processor 612 may include a driving controller 612-1. The driving controller 612-1 may include an interface converting circuit and a timing control circuit. The driving controller 612-1 receives an image signal from the main processor 611, converts the data format of the image signal such that the image signal is suitable for the interface specifications with the display module 640, and outputs image data. The driving controller 612-1 may output various control signals for driving the display module 640.

The auxiliary processor 612 may further include a data converting circuit 612-2, a gamma correcting circuit 612-3, and a rendering circuit 612-4. The data converting circuit 612-2 may receive the image data from the driving controller 612-1 and may compensates for the image data such that an image is displayed at a desired luminance according to characteristics of the electronic device 601 or setting of the user or may convert the image data to reduce power consumption or compensate for afterimages. The gamma correcting circuit 612-3 may convert the image data, a gamma reference voltage, or the like such that the image displayed on the electronic device 601 has desired gamma characteristics. The rendering circuit 612-4 may receive the image data from the driving controller 612-1 and may render the image data in consideration of a pixel arrangement of the display panel 641 applied to the electronic device 601. At least one of the data converting circuit 612-2, the gamma correcting circuit 612-3, and the rendering circuit 612-4 may be integrated into another component (e.g., the main processor 611 or the driving controller 612-1). At least one of the data converting circuit 612-2, the gamma correcting circuit 612-3, and the rendering circuit 612-4 may be integrated into a data driver 643.

The memory 620 may store various pieces of data, which are used by at least one component (e.g., the processor 610 or the sensor module 661) of the electronic device 601 and input data or output data for commands related thereto. The memory 620 may include at least one or more of the volatile memory 621 and the nonvolatile memory 622.

The input module 630 may receive, from the outside (e.g., the user or an external electronic device 602) of the electronic device 601, commands or data to be used in a components (e.g., the processor 610, the sensor module 661, or the audio output module 663) of the electronic device 601.

The input module 630 may include a first input module 631, through which the commands or data are input from the user, and a second input module 632 through which the commands or data are input from the external electronic device 602. The first input module 631 may include a microphone, a mouse, a keyboard, a key (e.g., a button), or a pen (e.g., a passive pen or an active pen). The second input module 632 may support a designated protocol capable of being connected to the external electronic device 602 by wire or wirelessly. According to an embodiment, the second input module 632 may include a high definition multimedia interface (HDMI), a universal serial bus (USB) interface, a secure digital (SD) card interface, or an audio interface. The second input module 632 may include a connector that may be physically connected to the external electronic device 602, for example, an HDMI connector, a USB connector, an SD card connector, or an audio connector (e.g., a headphone connector).

The display module 640 provides visual information to the user. The display module 640 may include the display panel 641, a scan driver 642, and the data driver 643. The display module 640 may further include a window, a chassis, a bracket, or the like for protecting the display panel 641. The display module 640 may further include a light emitting driver, a voltage generator, and the like. The voltage generator may output various voltages (e.g., the first and second driving voltages ELVDD and ELVSS (see FIG. 1)) for driving the display panel 641. The configuration of the display panel 641, the scan driver 642, the data driver 643, and the voltage generator is substantially similar to the configuration of the display panel DP, the first and second gate driving circuits 300, the data driving circuit 200, and the voltage generator 400 illustrated in FIG. 1, and thus detailed descriptions are omitted to avoid redundancy.

The power supply module 650 supplies power to the components of the electronic device 601. The power supply module 650 may include a battery that charges a power voltage. The battery may include a non-rechargeable primary cell, a rechargeable secondary cell, a fuel cell, or the like. The power supply module 650 may include a power management integrated circuit (PMIC). The PMIC supplies optimized power to the above-described modules and modules which will be described herein. The power supply module 650 may include a wireless power transmission/reception member electrically connected to the battery. The wireless power transmission/reception member may include a plurality of coil-shaped antenna radiators.

The electronic device 601 may further include the embedded module 660 and the external module 670. The embedded module 660 may include the sensor module 661, the antenna module 662, and the audio output module 663. The external module 670 may include the camera module 671, a light module 672, and the communication module 673.

The sensor module 661 may detect an input from the user's body or an input from a pen among the first input module 631, and may generate an electrical signal or data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include one of an optical-type fingerprint sensor, or a capacitance-type fingerprint sensor.

The input sensor 661-2 may generate a data value corresponding to coordinate information of an input by a body of the user or an input by a pen. The input sensor 661-2 generates the change in capacitance due to the input as the data value. The input sensor 661-2 may sense an input by a passive pen or may transmit or receive data to or from an active pen.

The input sensor 661-2 may also measure a biometric signal such as, for example, blood pressure, moisture, or body fat. In an example in which the user touches a part of the body to a sensor layer or sensing panel and does not move during a specific period, the input sensor 661-2 may detect the biometric signal and may output information desired by the user to the display module 640 based on a changes in electric fields caused by the part of the body.

The digitizer 661-3 may generate the data value corresponding to coordinate information of an input by the pen. The digitizer 661-3 generates an electromagnetic change amount due to the input as the data value. The digitizer 661-3 may sense input by the passive pen or transmit or receive data to or from the active pen.

At least one of the fingerprint sensor 661-1, the input sensor 661-2, and the digitizer 661-3 may be implemented as a sensor layer formed on the display panel 641 through a subsequent process. The fingerprint sensor 661-1, the input sensor 661-2, and the digitizer 661-3 may be placed on the upper side of the display panel 641, and one (e.g., the digitizer 661-3) of the fingerprint sensor 661-1, the input sensor 661-2, and the digitizer 661-3 may be placed on the lower side of the display panel 641.

At least two or more of the fingerprint sensor 661-1, the input sensor 661-2, and the digitizer 661-3 may be formed to be integrated into one sensing panel through the same process. In an example in which being integrated into one sensing panel, the sensing panel may be placed between the display panel 641 and a window placed on the upper side of the display panel 641. According to an embodiment, the sensing panel may be placed on a window, and the location of the sensing panel is not particularly limited thereto.

At least one of the fingerprint sensor 661-1, the input sensor 661-2, and the digitizer 661-3 may be built into the display panel 641. That is, at least one of the fingerprint sensor 661-1, the input sensor 661-2, and the digitizer 661-3 may be simultaneously formed through a process of forming elements (e.g., a light emitting element, a transistor, or the like) included in the display panel 641.

Besides, the sensor module 661 may generate an electrical signal or a data value corresponding to the internal state or external state of the electronic device 601. For example, the sensor module 661 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 662 may include one or more antennas to transmit or receive the signal or power to or from an external source. According to an embodiment, the communication module 673 may transmit or receive the signal to or from the external electronic device through the antenna suitable for a communication method. An antenna pattern of the antenna module 662 may be integrated into the input sensor 661-2 or one component (e.g., the display panel 641) of the display module 640.

The audio output module 663 may be a device for outputting an audio signal to the outside of the electronic device 601 and, for example, may include a speaker used for general purposes, such as, for example, multimedia playback or recording playback, and a receiver used for receiving a call. According to an embodiment, the receiver may be implemented separately from the speaker or may be integrated with the speaker. An output pattern of the audio signal output by the audio output module 663 may be integrated into the display module 640.

The camera module 671 may shoot a still image or a video image. According to an embodiment, the camera module 671 may include one or more lenses, an image sensor, or an image signal processor. The camera module 671 may further include an infrared camera capable of measuring the presence or absence of the user, a position of the user, a gaze of the user, or the like.

The light module 672 may provide light. The light module 672 may include a light emitting diode or a xenon lamp. The light module 672 may operate in conjunction with the camera module 671 or may operate independently from the camera module 1710.

The communication module 673 may support establishing a wired or wireless communication channel between the electronic device 601 and the external electronic device 602 and performing communication through the established communication channel. The communication module 673 may include one or all of wireless communication modules such as, for example, a cellular communication module, a short-range wireless communication module, or a global navigation satellite system (GNSS) communication module, or wired communication modules such as, for example, a local area network (LAN) communication module or a power line communication module. The communication module 673 may communicate with the external electronic device 602 through a short-range communication network such as, for example, Bluetooth, WiFi direct, or infrared data association (IrDA) or a long-range communication network such as, for example, a cellular network, Internet, or a computer network (e.g., the LAN or a wide area network (WAN)). The above-mentioned various communication modules 673 may be implemented into one chip or may be respectively implemented into separate chips.

The input module 630, the sensor module 661, the camera module 671, and the like may be utilized to control an operation of the display panel 641 in conjunction with the processor 610.

The processor 610 outputs commands or data to the display module 640, the audio output module 663, the camera module 671, or the light module 672 based on input data received from the input module 630. For example, the processor 610 may generate image data in response to input data applied through a mouse, an active pen, or the like to output the generated image data to the display module 640 or may generate command data in response to the input data to output the generated command data to the camera module 671 or the light module 672. In an example in which no input data is received from the input module 630 during a specific period, the processor 610 may switch an operation mode of the electronic device 601 to a low-power mode or a sleep mode to reduce power consumed in the electronic device 601.

The processor 610 outputs commands or data to the display module 640, the audio output module 663, the camera module 671, or the light module 672 based on sensing data received from the sensor module 661. For example, the processor 610 may compare authentication data authorized by the fingerprint sensor 661-1 with the authentication data stored in the memory 620, and then may execute an application depending on the comparison result. The processor 610 may execute commands or may output corresponding image data to the display module 640 based on sensing data sensed by the input sensor 661-2 or the digitizer 661-3. In an example in which the sensor module 661 includes a temperature sensor, the processor 610 receives temperature data regarding the measured temperature from the sensor module 661 and may further perform luminance correction on image data based on the temperature data.

The processor 610 may receive measurement data regarding the presence or absence of the user, the user's location, and the user's gaze from the camera module 671. The processor 610 may further perform luminance correction on the image data based on the measurement data. For example, the processor 610 that determines the presence or absence of the user through an input from the camera module 671 may output image data, of which the luminance is corrected, to the display module 640 through the data converting circuit 612-2 or the gamma correcting circuit 612-3.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 610 may communicate with the display module 640 through a mutually promised interface, and for example, may use any one of the above-described communication methods, and the present disclosure is not limited to the above-described communication methods.

According to the embodiments of the present disclosure, the gap between the support bars adjacent to each other among the support bars of the support part may be varied. Accordingly, deformation of the support part may be prevented when the display module and the support part are wound around the shaft. Thus, the display module disposed on the upper surface of the support part may be prevented from being damaged.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a display module comprising a display surface which displays an image;
a support part disposed on a rear surface of the display module which faces away from the display surface, the support part comprising a resin layer and a plurality of support bars arranged in the resin layer in an extension direction of the resin layer; and
a shaft connected to one end of the support part, the shaft having an axis of rotation which extends in a first direction, wherein the display module and the support part are windable around and unwindable from the shaft,
wherein a gap between support bars adjacent to each other among the support bars adjacent to the one end of the support part is greater than a gap between support bars adjacent to each other among the support bars adjacent to an opposite end of the support part.

2. The display device of claim 1, wherein:
the support part is defined by n areas, and n is a natural number greater than 1, and
when the display module is wound around the shaft:
an (n−1)^{th} area is defined as an area which surrounds the shaft once,
a first portion of an n^{th} area continuous with the (n−1)^{th} area surrounds a portion of the (n−1)^{th} area, and
a second portion of the n^{th} area continuous with the first portion is spaced apart from the (n−1)^{th} area.

3. The display device of claim 2, wherein:
a length of a first area adjacent to the shaft among the n areas in a second direction crossing the first direction when the support part is unrolled is determined by the following equation:
$${W}_{1} = 2 π ( r + t ) ,$$
a length of the n^{th} area of the support part in the second direction is determined by the following equation:
$${W}_{n} = 2 π ( r + nt ) ,$$
wherein:
r is a radius of the shaft, and
t is defined as a sum of a thickness of the support part and a thickness of the display module.

4. The display device of claim 3, wherein when the support part is unrolled, the n^{th} area has a larger area than the first area.

5. The display device of claim 3, wherein:
a gap between the support bars adjacent to each other when the support part is unrolled flat is determined by the following equation:
$${L}_{n} = {L}_{1} - {L}_{1} \times ( \frac{{W}_{n}}{{W}_{1}} - 1 ) = {L}_{1} - {L}_{1} \times ( \frac{( r + nt )}{( r + t )} - 1 )$$
wherein:
Lₙ is a distance between the support bars adjacent to each other among the support bars disposed in the n^{th} area, and
L₁ is defined as a gap between support bars adjacent to each other among the support bars disposed in the first area.

6. The display device of claim 5, wherein:
the gap between the support bars adjacent to each other among the support bars disposed in the first area is constant, and
a gap between the support bars adjacent to each other among the support bars disposed in the n^{th} area is constant.

7. The display device of claim 5, wherein the number of the support bars disposed in the n^{th} area is larger than the number of the support bars disposed in the (n−1)^{th} area.

8. The display device of claim 5, wherein a volume of the resin layer disposed between the support bars adjacent to each other among the support bars disposed in the n^{th} area is smaller than a volume of the resin layer disposed between support bars adjacent to each other among the support bars disposed in the (n−1)^{th} area.

9. The display device of claim 5, wherein:
a lower surface of the first area makes contact with an outer peripheral surface of the shaft when the display module is wound around the shaft, and
at least a portion of a lower surface of the n^{th} area makes contact with the display surface of the display module disposed on an upper surface of the (n−1)^{th} area.

10. The display device of claim 1, wherein the display module comprises:
a display panel which displays an image; and
a support plate disposed between the display panel and the support part, wherein a plurality of openings are defined in the support plate.

11. An electronic device comprising:
a power supply module; and
a display device connected to the power supply module, wherein the display device comprises:
a display module comprising a display surface which displays an image;
a support part disposed on a rear surface of the display module which faces away from the display surface, the support part comprising a resin layer and a plurality of support bars arranged in the resin layer in an extension direction of the resin layer; and
a shaft connected to one end of the support part, the shaft having an axis of rotation which extends in a first direction, wherein the display module and the support part are windable around and unwindable from the shaft,
wherein the support part is defined by n areas continuous with the one end, n is a natural number greater than 1, and a distance between support bars adjacent to each other decreases as n increases.

12. The electronic device of claim 11, wherein when the display module is wound around the shaft:
an (n−1)^{th} area is defined as an area which surrounds the shaft once,
a first portion of an n^{th} area continuous with the (n−1)^{th} area surrounds a portion of the (n−1)^{th} area, and
a second portion of the n^{th} area continuous with the first portion is spaced apart from the (n−1)^{th} area.

13. The electronic device of claim 11, wherein:
a length of a first area adjacent to the shaft among the n areas in a second direction crossing the first direction when the support part is unrolled is determined by the following equation:
$${W}_{1} = 2 π ( r + t ) ,$$
and
a length of an n^{th} area of the support part in the second direction is determined by the following equation:
$${W}_{n} = 2 π ( r + nt ) ,$$
wherein:
r is a radius of the shaft, and
t is defined as a sum of a thickness of the support part and a thickness of the display module.

14. The electronic device of claim 13, wherein:
a gap between the support bars adjacent to each other when the support part is unrolled flat is determined by the following equation:
$${L}_{n} = {L}_{1} - ( \frac{{W}_{n}}{{W}_{1}} - 1 ) ,$$
wherein:
Lₙ is a distance between the support bars adjacent to each other among the support bars disposed in the n^{th} area, and
L₁ is defined as a gap between support bars adjacent to each other among the support bars disposed in the first area.

15. The electronic device of claim 14, wherein the number of the support bars disposed in the n^{th} area is larger than the number of the support bars disposed in an (n−1)^{th} area.

16. The electronic device of claim 14, wherein a volume of the resin layer disposed between the support bars adjacent to each other among the support bars disposed in the n^{th} area is smaller than a volume of the resin layer disposed between support bars adjacent to each other among the support bars disposed in an (n−1)^{th} area.

17. The electronic device of claim 11, wherein:
the shaft comprises a step formed on an outer peripheral surface of the shaft, and
a curvature of the display module adjacent to the step is equal to a curvature of the shaft adjacent to the step.

18. The electronic device of claim 14, wherein:
a lower surface of the first area makes contact with an outer peripheral surface of the shaft when the display module is wound around the shaft, and
at least a portion of a lower surface of the n^{th} area makes contact with the display surface of the display module disposed on an upper surface of an (n−1)^{th} area.

19. The electronic device of claim 11, wherein the display module comprises:
a display panel which displays an image; and
a support plate disposed between the display panel and the support part, wherein a plurality of openings are defined in the support plate.

20. The electronic device of claim 11, further comprising:
a lifting part disposed on a lower surface of the support part, which faces wherein the lower surface faces away from an upper surface of the support part which faces the display module,
the lifting part extends in a second direction crossing the first direction when the display module is unwound from the shaft, and
the lifting part retracts in the second direction when the display module is wound around the shaft.
